(19) United States
(12) Patent Application Publication
(10) Pub. No.: US 2023/0189850 A1
(43) Pub. Date: Jun. 22, 2023

(54) MICROWAVABLE FROZEN STEAMED DUMPLINGS AND METHODS THEREOF

(71) Applicant: AJINOMOTO CO., INC., Tokyo (JP)

(72) Inventor: Shinji SASAKI, Portland, OR (US)

(73) Assignee: AJINOMOTO CO., INC., Tokyo (JP)

(21) Appl. No.: 18/085,830

(22) Filed: Dec. 21, 2022

Related U.S. Application Data
(60) Provisional application No. 63/265,900, filed on Dec. 22, 2021.

(51) Int. Cl. A23L 3/36; A21D 2/18; A23L 5/10; A21D 2/26; A21D 2/32; A23L 5/30

(52) U.S. Cl. CPC A23L 3/36; A21D 2/183; A23L 5/13; A21D 2/263; A21D 2/32; A23L 5/34

(57) ABSTRACT

A microwavable frozen steamed dumpling including a noodle-strip food and a batter, the batter containing water in an amount of at least 70 wt. %, based on a total weight of the batter, thereby enabling microwaving from a frozen state to provide cooked steamed dumplings with excellent mouthfeel, textural properties, and appearance. Also provided is a method of making the microwavable frozen steamed dumpling whereby the noodle-strip food is contacted with the batter and subsequently frozen to form the microwavable frozen steamed dumpling, and a method of preparing a cooked steamed dumpling whereby the microwavable frozen steamed dumpling is heated in a microwave oven.

### FIELD OF THE INVENTION

The present invention relates to a microwavable frozen steamed dumpling, a method of making the microwavable frozen steamed dumpling, and a method of preparing a cooked steamed dumpling from the microwavable frozen steamed dumpling.

### DISCUSSION OF THE BACKGROUND

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly nor impliedly admitted as prior art against the present invention.

Conventional steamed dumplings involve steaming a noodle-strip food, for example at around 100° C. for 20 to 40 minutes, to fully cook the inner ingredients to the requisite inner temperature while at the same time providing the familiar and desirable skin texture consumers find enjoyable. However, owing to the time-consuming nature of conventional steaming processes, food manufacturers have long sought to develop frozen steamed dumplings which consumers can cook using microwave ovens to a fully acceptable form equivalent to steamed dumplings made by conventional steaming processes.

While microwave heating of frozen food products offers unmatched convenience and safety, the unique heating mechanism of microwave ovens—which heat the food product from the inside out in a short period of time causes excessive hardening of the dumpling skin and provides dumplings with an unpleasant texture and mouthfeel (e.g., firm, rough, rubbery, or gummy). Such textural problems are exacerbated overtime as the microwaved dumpling is left to stand and as moisture on the surface of the skin evaporates.

Attempts to solve such skin texture and mouthfeel problems have involved adding more water to the dough of the noodle-strip food to increase water retention, using a boiling process to increase water retention, and minimizing the dough content of the noodle-strip food. Even still, frozen steamed dumpling products subjected to microwave heating fall short with respect to textural/mouthfeel properties when compared to dumplings obtained through traditional steaming processes.

Although a batter has been used for conventional fried or pan-seared dumplings (gyoza) as a way to stabilize a golden-brown color and to provide the crisp texture associated with fried or pan-seared dumplings, see US 2006/0263489 and US 2016/0242438 each incorporated herein by reference in its entirety, a batter has not been applied to dumplings of the steamed variety.

### SUMMARY OF THE INVENTION

The inventor's initial attempts to apply a conventional batter typically formulated with soy sauce, grain flour, starch, etc.—to steamed dumpling products to improve their microwavable characteristics from a frozen state were not successful. Instead, such conventional hatters were found to impart undesired coloration and an unpleasant texture/mouthfeel to the cooked steamed dumplings prepared from the microwaved steamed dumplings.

In view of the forgoing, there exists a need for new frozen steamed dumpling products which can be prepared in a microwave oven to provide cooked steamed dumplings with a moist, smooth, and tender skin texture, and with an appearance (shiny, white) similar to traditional steamed dumplings.

Accordingly, it is one object of the present invention to provide novel microwavable frozen steamed dumplings meeting the above criteria.

It is another object of the present disclosure to provide novel methods for making the microwavable frozen steamed dumplings.

It is another object of the present disclosure to provide novel methods for preparing cooked steamed dumplings through microwave heating of the microwavable frozen steamed dumplings.

These and other objects, which will become apparent during the following detailed description, have been achieved by the inventors' discovery that application of a batter in steamed dumpling products allows them to he microwaved from a frozen state to provide cooked steamed dumplings with excellent mouthfeel, textural properties, and appearance. To provide these advantages, the batter is formulated with a high proportion of water, and preferably without soy sauce, grain flour, starch, and protein.

Thus, the present invention provides:

(1) A microwavable frozen steamed dumpling, comprising:

a noodle-strip food; and

a batter;

wherein the batter comprises water in an amount of at least 70 wt. %, based on a total weight of the batter.

(2) The microwavable frozen steamed dumpling of (1), wherein the water is present in the batter in an amount of 81 to 91 wt. %, based on a total weight of the batter.

(3) The microwavable frozen steamed dumpling of (1) or (2), wherein the batter further comprises an oil.

(4) The microwavable frozen steamed dumpling of (3), wherein the oil is present in the batter in an amount of 5 to 25 wt. %, based on a total weight of the batter.

(5) The microwavable frozen steamed dumpling of (3) or (4), wherein a weight ratio of water to the oil in the batter is from 3:1 to 15:1.

(6) The microwavable frozen steamed dumpling of any one of (3) to (5), wherein the oil is canola oil.

(7) The microwavable frozen steamed dumpling of any one of (1) to (6), wherein the batter further comprises an emulsifier.

(8) The microwavable frozen steamed dumpling of (7), wherein the emulsifier is present in the halter in an amount of 0.1 to 5 wt. %, based on a total weight of the hatter.

(9) The microwavable frozen steamed dumpling of (7) or (8), wherein the emulsifier is at least one selected from the group consisting of casein and lecithin.

(10) The microwavable frozen steamed dumpling of any one of (1) to (9), wherein the batter further comprises a gum.

(11) The microwavable frozen steamed dumpling of (10), wherein the gum is present in the batter in an amount of 0.01 to 2 wt. %, based on a total weight of the batter.

(12) The microwavable frozen steamed dumpling of (10) or (11), wherein the gum is xanthan gum.

(13) The microwavable frozen steamed dumpling of any one of (1) to (12), wherein the batter is present in an amount of 1.5 to 5.5 g per piece of the noodle-strip food.

(14) The microwavable frozen steamed dumpling of any one of (1) to (13), wherein the batter is substantially free of grain flour.

(15) The microwavable frozen steamed dumpling of any one of (1) to (14), wherein the batter is substantially free of starch.

(16) The microwavable frozen steamed dumpling of any one of (1) to (15), wherein the batter is substantially free of protein.

(17) A method of making the microwavable frozen steamed dumpling of any one of to (16), comprising:

contacting the noodle-strip food with the batter; and

freezing to form the microwavable frozen steamed dumpling.

The method of (17), wherein the noodle-strip food is raw prior to contacting with the batter, and the method further comprises steaming the noodle-strip food after contacting with the batter.

(19) The method of (17), further comprising steaming the noodle-strip food prior to contacting with the batter.

(20) A method of preparing a cooked steamed dumpling, comprising:

heating the microwavable frozen steamed dumpling of any one of (1) to (16) in a microwave oven.

(21) The method of (20), wherein the microwavable frozen steamed dumpling is heated in the microwave oven in a steamable bag.

(22) The method of (20) or (21), wherein the microwavable frozen steamed dumpling is heated in the microwave oven without the use of a heat susceptor or a microwave-absorbing heat generator.

### BRIEF DESCRIPTION OF THE DRAWINGS

The foregoing paragraphs have been provided by way of general introduction, and are not intended to limit the scope of the following claims. The described embodiments, together with further advantages, will be best understood by reference to the following detailed description when considered in conjunction with the accompanying drawings, wherein:

FIG. 1 is a process flow diagram illustrating an example method for making the microwavable frozen steamed dumplings using a tray;

FIG. 2 is a process flow diagram illustrating another example method for making the microwavable frozen steamed dumplings using a tray;

FIG. 3 is a process flow diagram illustrating an example method for making the microwavable frozen steamed dumplings using a batter tank;

FIG. 4 is a process flow diagram illustrating another example method for making the microwavable frozen steamed dumplings using a batter tank.

### DETAILED DESCRIPTION OF THE INVENTION

In the following description, it is understood that other embodiments may be utilized and structural and operational changes may be made without departure from the scope of the is present embodiments disclosed herein.

### Definitions

As used herein, a “noodle-strip food” refers to a food in a state where a filling is packed or wrapped in a dough, the dough typically being made using a grain flour. References to a “steamed dumpling” or “steamed dumplings” throughout the present disclosure refer to those dumplings having a moist, smooth, and tender skin texture as well as a shiny white/off-white appearance. These terms thus differ from “fried,” “pan-fried,” or “pan-seared” dumplings {e. g., gyoza}, a different dumpling class, which tend to have a crispier texture and a golden-brown appearance.

As used herein, the phrase “substantially free”, unless otherwise specified, refers to a composition/material which contains less than 1 wt. %, preferably less than 0.5 wt. %, preferably less than 0.1 wt. %, preferably less than 0.05 wt. %, preferably less than 0.001 wt. %, preferably 0 wt. % of a particular component, relative to a total weight of the composition/material.

As used herein, the terms “optional” or “optionally” means that the subsequently described event(s) can or cannot occur or the subsequently described component(s) may or may not be present (e.g., 0 wt. %).

### Microwavable Frozen Steamed Dumpling

The present disclosure is directed to microwavable frozen steamed dumplings, which are steamed dumplings that can he stored in a frozen state, and which upon microwave heating provide cooked steamed dumplings with a pleasing appearance and texture. As will become clear, the use of a batter with a high water content contributes to this ability to be microwaved.

The microwavable frozen steamed dumplings of the present disclosure generally include (i) a noodle-strip food containing one or more filling ingredients wrapped inside a dough (skin), and (ii) a batter. The batter may cover or coat an entire surface of the noodle-strip food, or may partially cover or coat a surface of the noodle-strip food, for example, the batter may be applied to one side (e.g., the top or the bottom) of the noodle-strip food. The amount of batter used per piece of the noodle-strip food may vary depending on the particular steamed dumpling product, but the batter is generally used in an amount of at least 1.1 g, preferably at least 1.2 g, preferably at least 1.3 g, preferably at least 1.5 g, preferably at least 1.7 g, preferably at least 2 g, preferably at least 2.5 g, preferably at least 3 g, and up to 5.5 g, preferably up to 5 g, preferably up to 4.5 g, preferably up to 4 g, preferably up to 3.5 g, per piece of the noodle-strip food. When the batter is used in an amount within the aforementioned range, the cooked steamed dumplings tend to have an advantageous texture that is not too hard (usually resulting from too little batter) and not too soft (usually resulting from too much batter). Of course, the size and type of the noodle-strip food may affect the amount of hatter needed, and so the amount of batter may be adjusted within these ranges, and even outside of these ranges, to provide an appropriate texture upon microwave heating.

The microwavable frozen steamed dumplings can be formed into a variety of shapes, including, but not limited to, a traditional ‘half-moon’ shape, a triangle shape, a cone shape, a muffin shape, a loaf shape, a ball shape, a folded ring shape, among many others, including any desired skin embossing pattern.

### <Batter>

In order to provide frozen steamed dumplings which can be easily cooked through microwave cooking to provide cooked steamed dumplings with excellent appearance (e.g., color, shine) and mouthfeel/texture (referred to herein as “microwavable”), the inventors have found that advantageous batters include a high proportion of water. Such a high water content is also preferred for solidification of the batter upon freezing.

Suitable batters are those containing water generally in an amount of at least 70 wt. %, preferably at least 72 wt. %, preferably at least 74 wt. %, preferably at least 76 wt. %, preferably at least 77 wt. %, preferably at least 78 wt. %, preferably at least 79 wt. %, preferably at least 80 wt. %, preferably at least 81 wt. %, preferably at least 82 wt. %, preferably at least 83 wt. %, preferably at least 84 wt. %, preferably at least 85 wt. %, preferably at least 86 wt. %, preferably at least 87 wt. %, preferably at least 88 wt. %, preferably at least 89 wt. %, and up to 94 wt. %, preferably up to 93 wt. %, preferably up to 92 wt. %, preferably up to 91 wt. %, preferably up to 90 wt. %, based on a total weight of the batter. At water contents below the aforementioned minimum value, the frozen steamed dumplings may tend to have a dry, rough, firm, gelled, and/or chewy mouthfeel/texture after microwave heating.

The batter may also include an oil. The oil may serve to provide a moistening (shine) effect to improve the appearance of the cooked steamed dumpling and to minimize the tackiness so as to prevent each dumpling from sticking to each other and/or the surroundings.

As the oil component, various edible oils may be utilized, with plant-based oils being preferred. Suitable examples of plant-based oils may include, but are not limited to, soybean oil, olive oil, corn oil, vegetable oil, canola oil, jojoba oil, sesame oil, coconut oil, palm oil, rice germ oil (rice bran oil), or any other vegetable oil known in the art, as well as mixtures thereof In preferred embodiments, the oil is canola oil.

The amount of oil may be adjusted as needed to provide suitable anti-sticking properties and cooked steamed dumpling appearance, for example. Typical oil contents may range from at least 5 wt. %, preferably at least 6 wt. %, preferably at least 7 wt. %, preferably at least 8 wt. %, preferably at least 9 wt. %, and up to 25 wt. %, preferably up to 24 wt. %, preferably up to 22 wt. %, preferably up to 20 wt. %, preferably up to 18 wt. %, preferably up to 16 wt. %, preferably up to 14 wt. %, preferably up to 12 wt. %, based on a total weight of the batter.

In terms of achieving a. desirable combination of both cooked steamed. dumpling appearance and. texture/mouthfeel properties, preferred batters are those formulated generally with a weight ratio of water to the oil of at least 3:1, preferably at least 3.2:1, preferably at least 3.5:1, preferably at least 4:1, preferably at least 4.5:1, preferably at least 5:1, and up to 15:1, preferably up to 13:1, preferably up to 11:1, preferably up to 10:1, preferably up to 8:1, preferably up to 7:1, preferably up to 6:1.

The batter may also include an emulsifier, for example, to stabilize a batter containing a mixture of water and oil, The amount of emulsifier may be adjusted to provide acceptable emulsification based on, inter alia, the emulsifier used, the water to oil ratio, etc. Typically, the batter may be formulated with the emulsifier in an amount of at least 0.1 wt. %, preferably at least 0.2 wt. %, preferably at least 0.5 wt. %, preferably at least 1 wt. %, and up to 5 wt. %, preferably up to 4 wt. %, preferably up to 3 wt. %, preferably up to 2 wt. %, based on a total weight of the batter.

Any type of emulsifier may be used provided that it is edible. Examples of emulsifiers may include, but are not limited to, (i) lecithin such as lecithin derived from soybean, egg, or the like, modified or enzymically degraded lecithins, or other phospholipids/phospholipid mixtures such as one or more of phosphatidic acid, phosphatidylethanolamine, phosphatidylcholine, phosphatidylserine phosphatidylinositol, phosphatidylinositol is phosphate, phosphatidylinositol bisphosphate, phosphatidylinositol triphosphate, ceramide phosphoryl choline, ceramide phosphorylethanolamine and ceramide phosphoryl glycerol, with specific mention being made to lecithin products WELKIN, ULTRALEC, BEAKIN, PERFORMIX, and THERMOLEC, each available from Archer Daniels Midland; (ii) casein (including caseinate salts such as sodium caseinate, calcium caseinate, etc.), with specific mention being made to EXCELLION CALCIUM CASEMATE S, EXCELLION EM 7, EXCELLION EM 9, EXCELLION SODIUM CASEINATE, each available from FrieslandCampina; (iii) polysorbates such as polyoxyethylene sorbitan monolaurate, polyoxyethylene sorbitan monopalmitate, polyoxyethylene sorbitan monostearate, polyoxyethylene sorbitan monooleate, and sorbitan tristearate, (iv) sugar esters such as sucrose esters (e.g., sucrose monostearate); (v) monoglycerides such as glycerol monostearate; (vi) polyglycerin fatty acid esters such as polyglycerol esters of fatty acids (E475) and polyglycerol polyricinoleate (E476); and (vii) polypropylene glycol fatty acid (mono- or di-) esters such as distilled propylene glycol monostearate (PGMS). The emulsifiers may be used singly, or in combination. In preferred embodiments, the emulsifier is casein and/or lecithin, more preferably casein.

The batter may be optionally formulated with a stabilizing agent. When the batter is in the form of a pre-made batter (i.e., all ingredients are combined to form the batter which may be optionally packaged and/or stored, and is thereafter applied to the noodle-strip food after a certain period of time, such as 15 minutes or longer), it may be desirable to use a stabilizing agent to improve the stability of the batter. The use of a stabilizing agent thus enables the batter to be pre-made and optionally packaged and stored for prolonged periods of time while minimizing or preventing phase separation. Conversely, the usefulness of a stabilizing agent may be diminished when the batter is newly made such as when the individual batter components are combined in a stepwise fashion as they are being applied to the noodle-strip food or just prior to contact with the noodle-strip food, such as within 15 minutes of being combined. n such scenarios, it may be desirable to exclude a stabilizing agent from the batter. In terms of enhanced productivity, preferred batters are pre-made batters formulated with a stabilizing agent.

Examples of stabilizing agents may include, but are not limited to,
modified egg products that are fortified with additional emulsifiers such as those emulsifiers described above, or are enzyme modified (e.g., modified with a phospholipase such as phospholipase A) including such modified versions of egg yolk, egg whites, and whole eggs;
gums (also called hydrocolloids), such as xanthan gum (e.g., SATIAXANE CX 90, available from Cargill), guar gum, ghatti gum, karaya gum, tragacanth gum, carrageenan, psyllium seed gum, tamarind seed gum, alginates including salts of alginic acid (e.g., sodium alginate, potassium alginate, ammonium alginate, calcium alginate, etc.) and modified alginates (e.g., propylene glycol alginates, with specific mention being made to KIMILOID products such as KIMILOID HV, available from Kimica Corp.), locust bean gum, agar, tapioca, gelatin, pectin, gum arabic (acacia), including mixtures or blends of gums such as CARAGUM available from TIC gums; said gums being used alone or optionally in combination with a gelling agent such as calcium acetate, calcium citrate, calcium gluconate, calcium glycerol phosphate, mono-, di-, and tri-calcium phosphate, calcium sulfate, calcium carbonate, calcium lactate, and calcium phosphite; and
modified cellulose polymers such as methylcellulose (MC), ethyl cellulose (EC), hydroxyethyl cellulose (HEC), hydroxypropyl cellulose (HPC), hydroxyethyl methyl cellulose (HEMC), ethyl hydroxyethyl cellulose (EHEC), methyl ethyl hydroxyethyl cellulose (MEHEC), hydroxypropyl methyl cellulose (HPMC), carboxymethyl cellulose (CMC), polyanionic cellulose (PAC), as well as modified versions thereof, for example, hydrophobically modified versions of any of the above;
as well as mixtures thereof.

In some embodiments, the batter is formulated with a. gum, and, preferably, no other stabilizing agents are present. In preferred embodiments, the stabilizing agent is xanthan gum.

When employed, the stabilizing agent (e.g., gum) may be used generally in an amount of at least 0.01 wt. %, preferably at least 0.05 wt. %, preferably at least 0.1 wt. %, preferably at least 0.2 wt. %, preferably at least 0.3 wt. %, preferably at least 0.4 wt. %, preferably at least 0.5 wt. %, and up to 2 wt. %, preferably up to 1.5 wt. %, preferably up to 1 wt. %, preferably up to 0.8 wt. %, preferably up to 0.6 wt. %, based on a total weight of the batter.

One or more additives may be optionally formulated into the batter in art appropriate levels. A non-exhaustive list of optional additives includes, but is not limited to, a thickening agent, a colorant, a preservative, a flavoring/seasoning (e.g., salt, sugar, etc.), and a surfactant.

Examples of thickening agents may include, but are not limited to, fiber such as wheat fiber, corn fiber, barley fiber, rye fiber, oat fiber, rice fiber, cellulose powder fiber, sugar beet fiber, inulin, soy fiber, pea fiber, citrus fiber, cottonseed fiber, mustard fiber, and leguminous fiber, as well as mixtures thereof. The thickening agent may be optionally used generally in amounts up to 5 wt. %, preferably up to 4 wt. %, preferably up to 3 wt. %, preferably up to 2 wt. %, preferably up to 1 wt. %, preferably up to 0.5 wt. %, preferably up to 0.1 wt. %, based on a total weight of the batter.

It is generally desirable for the batter described herein to impart a white, off-white, or cream color to the dumpling skin (after cooking), and batters which impart such a color without use of colorants are particularly preferred. However, when it is desired, various colorants, including both pigments and dyes, may optionally be added into the batter, singly or in combination, to produce cooked steamed dumplings having a variety of colors (e.g., yellow-orange, red, orange, green, etc.) including, but not limited to, turmeric, saffron, golden beet dye, beta-carotene, Yellow No. 5 (Tartrazine, E102), Yellow No. 6 (Sunset Yellow FCF, E110), and Quinoline Yellow (E104), Blue No. 1 (Brilliant Blue FCF, E133), Blue No. 2 (Indigotine, E132), Green No. 3 (Fast Green FCF, E143), Red No. 3 (Ervthrosine, E127), Red No. 40 (Altura Red AC, E129), as well as mixtures thereof. When desired, the colorant is typically employed in the batter in an amount of up to 1 wt. %, preferably up to 0.5 wt. %, preferably up to 0.3 wt. %, preferably up to 0.2 wt. %, preferably up to 0.1 wt. %, preferably up to 0.05 wt. %, based on a total weight of the batter.

Preservatives suitable for use in food are well-known to those skilled in the art. The preservatives may act as antimicrobials, stabilizers, and/or antioxidants to prevent the growth of mold, the growth of bacteria, degradation or chemical breakdown (e.g,, oxidative degradation), etc., so as to keep the batter, and by connection the noodle-strip food and its dough and/or filling ingredients, fresh for longer periods of time. Illustrative examples include, but are not limited to, benzoates (e.g., sodium benzoate, benzoic acid), sorbates (e.g., sorbic acid, sodium sorbate, potassium sorbate), citrates (e.g., citric acid), propionates (e.g., propionic acid), ascorbates (e.g., ascorbic acid, sodium ascorbate), and mixtures thereof. As the microwavable frozen steamed dumplings of the present disclosure are intended to be kept in cold/freezer storage until ready-to-eat, the use of preservatives is not necessary or preferred. However, one or more preservatives may be optionally included in the batter when desired generally in amounts from 0.001 wt. %, preferably from 0.01 wt. %, preferably from 0.1 wt. %, and up to 2 wt. %, preferably up to 1 wt. %, preferably up to 0.5 wt. %, based on a total weight of the batter.

The batter may also be optionally formulated with various flavorings/seasonings, for example, generally in amounts up to 5 wt. %, preferably up to 4 wt. %, preferably up to 3 wt. %, preferably up to 2 wt. %, preferably up to 1 wt. %, preferably up to 0.5 wt. %, preferably up to 0.1 wt. %, based on a total weight of the batter. As the flavorings/seasonings, particular mention is made to salts such as sodium chloride, calcium chloride, potassium chloride, magnesium chloride, as well as sulfate salts of calcium, potassium, and magnesium, and mixtures thereof, for example sea salt, and the like; sugar or sweetening agents such as sucrose, maltitol, sorbitol, lactose, trehalose, and the like; powder soy; a yeast extract; a protein hydrolysate; a meat extract; a seafood extract; a vegetable extract; sake; mirin; vinegar; a glutamate or amino acid seasoning such as monosodium glutamate (MSG); a nucleotide seasoning such as inosine monophosphate (IMP) and guanosine monophosphate (GMP); as well as mixtures thereof. While the batter may be optionally formulated with soy sauce as a flavoring/seasoning, soy sauce has been found to impart an unpleasant coloration to the skin of the cooked steamed dumpling, and thus it is preferred that the batter is substantially free of soy sauce. In some embodiments, the hatter is substantially free of flavorings/seasonings, with particular mention being made to trehalose.

Food-grade surfactants may be optionally included into the batter disclosed herein, including, but are not limited to, glycerides (mono-, di-, and tri-glycerides), lactylates, lactates, phosphates, stearates, sorbates, sorbitan esters, and the like, with specific mention being made to acetylated hydrogenated coconut glycerides, acetylated hydrogenated cottonseed glyceride, acetylated hydrogenated soybean oil glyceride, acetylated lard is glyceride, acetylated mono- and diglycerides of fatty acids, acetylated tartaric acid esters of mono- and diglycerides of fatty acids, acyl lactylates, calcium lactate, calcium phosphate monobasic monohydrate, calcium phosphate tribasic, calcium/sodium stearoyl lactylate, calcium stearate, calcium stearoyl lactylate, canola oil glyceride, capric triglyceride, caprylic/capric triglyceride, and capryllic triglyceride, just to name a few.

While the batter of the present disclosure may be optionally formulated with the aforementioned additives, it has been found that the inclusion of other certain common batter ingredients such as grain flour, starch, and protein, provide cooked steamed dumplings with a poor texture, stickiness, and an unpleasant mouthfeel. Thus, in preferred embodiments, the batter is substantially free of one or more of grain flour, starch, and protein.

Examples of grain flour may include, but are not limited to, rice flour (including those derived from long grain, medium grain, or short grain rice, and glutinous or nonglutinous), wheat flour, corn flour, potato flour, tapioca flour (derived from cassava), amaranth flour, arrowroot flour, sorghum flour (Jowar), soybean flour, adzuki flour, teff flour, chia seed flour, barley flour, pure buckwheat flour, gram flour (derived from chick-peas), millet flour (e.g., Chinese millet, Japanese millet, proso millet, etc.), oat flour, quinoa flour, almond flour, coconut flour, chestnut flour, tigemut flour, and garbanzo flour, as well as combinations thereof.

Examples of starch may include, but are not limited to, cornstarch including waxy cornstarch, tapioca starch, arrowroot starch, wheat starch, rice starch including glutinous or nonglutinous rice starch, potato starch, sweet potato starch, sago starch, and mung bean starch, as well as modified or pre-gelatinized versions of such starches, and mixtures thereof.

Examples of protein may include, but are not limited to, albumin powder, separated soy protein, defatted powdered milk, powdered wheat protein, dried whole egg powder (e.g., lyophilized whole eggs), egg yolk powder (e.g., lyophilized egg yolks), and egg white powder (e.g., lyophilized egg whites).

Further, while the use of leavening agents are contemplated, preferred batters are those which a e substantially free of leavening agents. Leavening agents may include both enzyme leavening agents as well as chemical leavening agents, with specific mention being made to Saccharomyces cerevisiae (e.g., baker's yeast, beer), Clostridium perfringens, as well as enzymes described in US 2003/0206994A1—incorporated herein by reference in its entirety, baking soda, baking powders that include baking soda. and/or acids/acid salts like cream of tartar, tartaric acid, monocalcium phosphate, sodium aluminum sulfate, dicalcium phosphate, glucono delta-lactone, ammonium bicarbonate, ammonium carbonate, including any hydrates thereof, and any mixtures thereof.

In preferred embodiments, the batter of the present disclosure comprises, consists essentially of, or consists of, water, the oil, the emulsifier (e.g., casein), and optionally a stabilizing agent (e.g., xanthan gum).

### <Noodle-Strip Food>

The noodle-strip food used in the microwavable frozen steamed dumplings of the present disclosure is not particularly limited and may be formed from a variety of filling ingredients and doughs as is known by those of ordinary skill in the art.

In terms of the filling ingredients, it is to be readily appreciated by those of ordinary skill in the art that a wide variety of filling ingredients may be included in the noodle-strip food for preparation of various steamed dumpling types, including meat-containing steamed dumplings, vegetarian steamed dumplings, and dessert-style steamed dumplings, and thus the filling ingredient is not particularly limited so long as the filling ingredient can be cooked/heated to satisfaction in a microwave oven.

Typical/traditional filling ingredients for steamed dumplings may be included in the noodle-strip food in art appropriate quantities, including meat, a vegetable, raw materials such as a nut, a nutrient, a flavoring/seasoning, an emulsifier, a stabilizing agent, a thickening agent, a colorant, a preservative, a surfactant, a starch, a protein, an oil, a sauce, and the like, including those disclosed above, with specific mention being made to duck, pork (e.g., pork mined meat), chicken, beef, lamb, fish, shrimp and other seafood, mutton, hoar, edamame, mushrooms, lettuce, carrots, bamboo shoots, beans, noodles such as bean noodles, corn, zucchini, radishes, peas, cabbage, leek, onions, green onions, ginger, peanuts, almonds, coconut, cardamom, desserts, custard, soy sauce, teriyaki sauce/seasoning, wine, mirin, salt, pepper, sugar, yeast extract, oil, chicken base, chicken stock, beef stock, cornstarch, fig, among many others. When meat products or other raw materials are to be used as filling ingredient(s), pre-cooking, disinfecting, or other sterilization procedures are preferably employed.

The dough of the noodle-strip food herein is not particularly limited, and may be made with a variety of ingredients known to ordinary skill in the art. Non-limiting examples of dough ingredients may include, but are not limited to, a flour base containing a grain flour (e.g., wheat flour, rice flour, etc.), an oil, water, a stabilizing agent, a colorant, a preservative, a flavoring/seasoning, an enzyme (e.g., binding enzymes such as transglutaminase enzyme), an emulsifier, a surfactant, a thickening agent, a starch, a protein, a sauce, among others.

### A Method of Making a Microwavable Frozen Steamed Dumpling

The present disclosure also provides methods of making the microwavable frozen steamed dumpling, in one or more of its embodiments.

Regarding the noodle-strip food, the methods herein are not particularly limited, and a variety of techniques and processes known to those of ordinary skill in the art may be employed for providing the noodle-strip food, including manual methods (e.g., manual steps of mixing/kneading the dough, mixing the filling ingredients, forming/shaping the noodle strip food by hand, etc.) as well as benchtop or line-run manufacturing techniques using mechanical equipment (e.g., for commercial manufacture).

By way of example, the dough may be prepared using a blender, a countertop mixer, or a commercial mixer to combine all ingredients, and then kneaded, worked, pressed, and/or folded, for example using a loafer. Separately, the filling ingredients may be added to a filling mixer, such as a countertop mixer or a commercial mixer to generate the desired filling mixture. Next, the filling mixture from the filling mixer and the dough may each be conveyed/added to a forming machine which assembles and forms/shapes the noodle-strip food. Suitable forming machines for forming noodle-strip foods are known to those of ordinary skill in the art, and the disclosed methods are not limited to a particular type of forming machine. Suitable forming machines may be configured to form the noodle-strip food utilizing sequential operations. By way of example, the dough may be sheeted through one or more mills to provide a dough sheet of desirable quality and thickness. Next, the filling mixture may be injected between dough sheets, and the filled dough may then be passed through a die of predetermined geometric sections, such as semicircle, half-moon shape, etc., and as the filled dough passes, the noodle-strip food may be cut away from the dough sheet, resulting in a filled and sealed noodle-strip food. Alternatively, the dough sheet may pass through a die of predetermined geometric sections to form a geometric dough cutout. The filling mixture may then be disposed upon the dough cutout, and the dough cutout containing the filling mixture may be folded, shaped, pressed, and/or sealed to form the noddle-strip food, e.g., in a half-moon shape. Additional shaping and/or embossing operations may be optionally performed to work the noodle-strip food into any desired shape or design.

Embodiments of the batter described herein may be prepared by any suitable technique known to those of ordinary skill in the art, for example by combining the water, the oil, the emulsifier, and any other desired ingredient such as the stabilizing agent (e.g., gum). an additive, etc., in any order, with optional mixing (e.g., stirring, agitating, whisking, beating, whipping, and/or blending). Any mixing may be performed manually or mechanically such as by using a countertop mixer or a commercial mixer. In some embodiments, all desired ingredients may he combined to form the batter, which may he optionally packaged and/or stored, in advance of being placed into contact with the noodle-strip food, for example at least 15 minutes, preferably at least 20 minutes, preferably at least 25 minutes, preferably least 30 minutes, preferably at least 40 minutes, preferably at least 50 minutes, preferably at least 60 minutes prior to contact with the noodle-strip food (herein referred to as a “pre-made batter”). In alternative embodiments, the batter may be made whole as the various ingredients are applied to the noodle strip food or shortly prior (e.g., within 15 minutes, preferably within 10 minutes, preferably within 5 minutes, preferably within 1 minute, preferably within 30 seconds) to being brought into contact with the noodle-strip food (herein referred to as a “newly made batter”). For example, for a newly made batter, the desired ingredients used to construct the batter may be applied separately or in different stages/steps to the noodle-stripfood, e.g., one at a time, thereby forming the batter during the addition to the noodle-strip food. In another example of a newly made batter, all desired ingredients used to construct the batter may be freshly assembled just prior within 15 minutes) to being brought into contact with the noodle-strip food.

Various methods and a variety of techniques and processes known to those of ordinary skill in the art may be employed for making the microwavable frozen steamed dumpling of the present disclosure. The methods generally involve bringing into contact the noodle-strip food with the batter, and freezing to form the microwavable frozen steamed dumpling. In some embodiments, the noodle-strip food is raw prior to contacting the batter. Here, it is desirable to steam the noodle-strip food after contact with the batter, whereby the noodle-strip food and batter are steamed together prior to being frozen. In some embodiments, the noodle-strip food is steamed prior to being brought into contact with the batter. In such cases, the batter may not be subject to a steaming operation.

The noodle-strip food may be brought into contact with the batter using any suitable technique known to those of ordinary skill in the art, for example by applying the batter to the noodle-strip food, such as through spraying, basting, coating, spreading, etc.; by placing the noodle-strip food onto the batter; by dipping, dropping, or submersing the noodle strip food into a tank of the batter, etc.; any of which may be performed using either a pre-made batter or a newly made batter.

Steaming may be performed using a variety of steaming equipment, examples of which may include, but are not limited to, mesh conveyer-tunnel systems, steam baskets, rotary screw or rotary drum steamers, reel steamers, pipe steamers, steam blanchers, individual quick blanchers (IQB) or other multi-stage blanching systems, batch fluidized-bed blanchers (using a mixture of air and steam), any of which may be optionally outfitted with a built-in cooling zone for halting the steaming process, or any other steaming equipment capable of generating an atmosphere of saturated steam. The steaming equipment may be optionally outfitted with a gravity chute or in-feed flume and/or a discharge chute. The noodle-strip food may be optionally advanced, for example, using a rotating auger or helical screw, a conveyer belt, etc., as deemed appropriate. For example, the steaming operation may be performed by subjecting the noodle-strip food (and optionally hatter;) to steam while being conveyed on a belt. The steam may have a temperature of around 100° C., such as about 95 to 105° C., or an atmosphere of saturated steam may be generated at elevated pressures enabling steam of higher temperatures to be utilized, as is known by those of ordinary skill in the art. The steaming times may vary depending on the steaming temperatures utilized, the thickness of the dough of the noodle-strip food, the type/nature of the noodle-strip food, etc. Typically, steaming is performed for at least 1 minute, preferably at least 2 minutes, preferably at least 3 minutes, preferably at least 4 minutes, preferably at least 5 minutes, preferably at least 10 minutes, preferably at least 15 minutes, preferably at least 20 minutes, and up to 60 minutes, preferably up to 50 minutes, preferably up to 40 minutes, preferably up to 30 minutes, preferably up to 25 minutes.

While steaming to any desired cooking degree may be performed, preferred steaming operations are those which result in only partial cooking of the noodle-strip food (steam blanching), whereby the starch component present in the dough of the noodle-strip food is partially converted into a gelatinous form, but where the steaming operation is stopped before the noodle-strip food is completely cooked (i.e., stopped before the starch component of the dough becomes fully cooked). It should also be noted that while steaming-based methods are preferred herein, other types of cooking operations are contemplated, such as boiling, hot water blanching, baking, etc. which may be used in lieu of, or in addition to, steaming.

After the steaming operation is deemed complete, the noodle-strip food (and optionally batter) may then be cooled, preferably through rapid cooling, to halt the cooking process. Rapid cooling may involve the use of cold water, cooled air, or a combination of both. Cooling with cold water may involve immersion into a cold water bath/cold water chiller, or through the use of a cold water spray. The cold water may generally have a temperature of at least 1° C., preferably at least 2° C., preferably at least 3° C., preferably at least 4° C., and up to 15° C., preferably up to 10 preferably up to 8° C., preferably up to 6° C., preferably up to 5° C. Cooled air cooling may involve the circulation of cooled air, for example, using cooling fans. The cooling operation may take place in stand-alone equipment, or may be associated with the steaming equipment, for instance where the steaming equipment includes both a steaming/cooking zone and a cooling zone in one device. The type of cooling utilized, the temperature of the cold water and/or cooled air, as well as the cooling exposure time is not particularly limited so long as the cooling operation halts the steaming operation and prevents overcooking (e,g., complete cooking). Typically, the noodle-strip food (and optionally batter) is cooled for at least 30 seconds, preferably at least 1 minute, preferably at least 2 minutes, preferably at least 3 minutes, and up to 20 minutes, preferably up to 15 minutes, preferably up to 10 minutes, preferably up to 8 minutes, preferably up to 6 minutes, preferably up to 4 minutes.

Freezing to form the microwavable frozen steamed dumplings may be carried out using a variety of freezing techniques, including standard freezing practices whereby the noodle-strip food and batter are subjected to temperatures at near the freezing point of water (e.g., 0 to 4° C.), and flash freezing processes whereby the noodle-strip food and batter are subjected to cryogenic temperatures well below the freezing point of water. Freezing may be performed using a traditional standing freezer (e.g., a commercial freezer), a spiral belt freezer, a plate freezer, and the like. From the standpoint of commercial throughput, preferred methods herein include the use of belt/in-line freezers such as spiral freezers.

The microwavable frozen steamed dumplings thus obtained may be packaged (e.g., in a bag, box, carton, tray, etc.) and optionally stored using conventional packaging techniques known by those of ordinary skill in the art, including optional inerting (deoxidizing) procedures. The microwavable frozen steamed dumplings may be packaged individually or a plurality of microwavable frozen steamed dumplings may be packaged together. For instance, 2 to 20, preferably 4 to 18, preferably 6 to 16, preferably 8 to 12, preferably 10 microwavable frozen steamed dumplings may be packaged together e.g., per steamable bag, ready for use by the consumer.

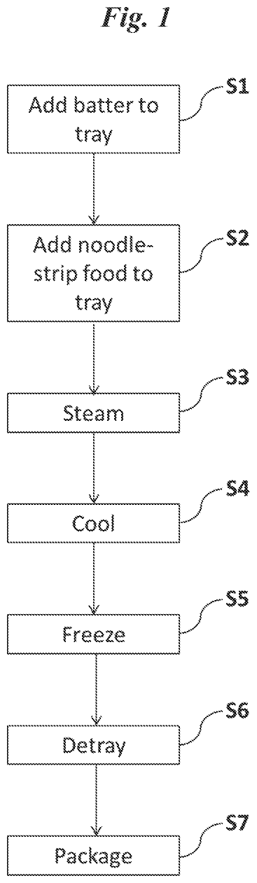

For the purposes of illustration, several exemplary methods will now be discussed with reference to the process flow diagrams shown in FIGS. 1-4. Depicted in FIG. 1 is a method involving the use of a tray. The method may first involve adding the batter (e.g., a pre-made batter or a newly made batter) to the tray (S1). The noodle-strip food may then be added to the tray containing the batter (S2). For example, the noodle-strip food may be placed on or submerged in the batter. When the noodle-strip food added to the tray is raw, the method may then involve steaming (S3) the noodle-strip food. Here, the noodle-strip food. and the batter are steamed together since the steaming operation is performed after contact with the batter has taken place. After cooling (S4) to stop the steaming process, the tray containing the noodle-strip food and batter may then be subjected to a freezing operation (S5) to form the microwavable frozen steamed dumplings, which may be removed from the tray (i.e. detrayed) (S6) and packaged (S7). Preferred trays for use in such methods are those containing a plurality of cavities/compartments (similar to an ice cube tray), with each cavity/compartment being configured to hold a single dumpling. As a result, a single tray containing a plurality of cavities/compartments (e.g., 10) is capable of producing a plurality (e.g., 10) of microwavable frozen steamed dumplings.

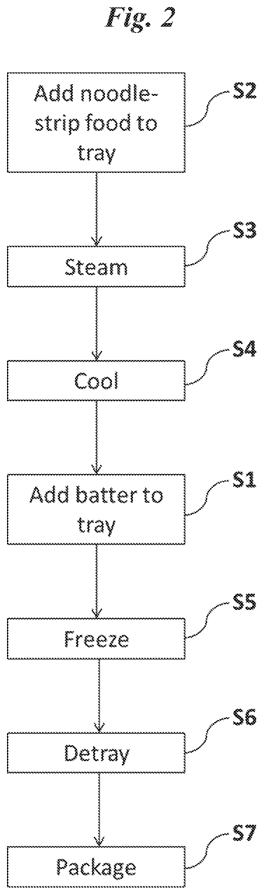

Depicted in FIG. 2 is an alternative method involving the use of a tray. The method may first involve adding the noodle-strip food to the tray (S2), followed by steaming (S3) the noodle-strip food. Here, the noodle-strip food is steamed prior to contact with the batter. After cooling (S4) to stop the steaming process, the batter (e.g., a pre-made batter or a newly made batter) may be applied to the noodle-strip food in the tray (S1). The tray containing the noodle-strip food and batter may then be subjected to a freezing operation (S5) to form the microwavable frozen steamed dumplings, which may be removed from the tray detrayed) (S6) and packaged (S7). As described above, preferred trays for use in such methods are those containing a plurality of cavities/compartments, with each cavity/compartment being configured to hold a single dumpling. As a result, a single tray containing a plurality of cavities/compartments (e.g., 10) is capable of producing a plurality (e.g., 10) of microwavable frozen steamed dumplings.

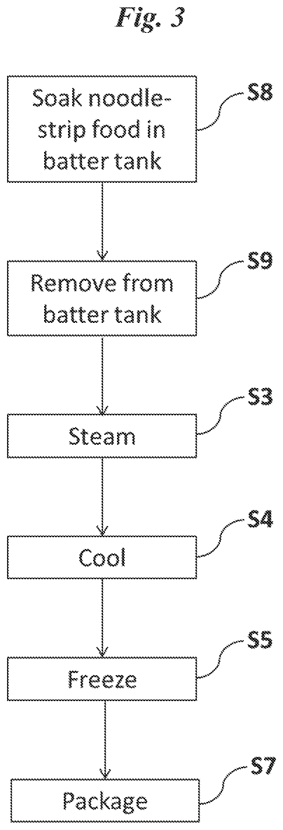

Depicted in FIG. 3 is a method involving the use of a batter tank. The method may first involve soaking a noodle-trip food, which is raw, in a batter tank containing a pre-made batter or a newly made batter (S8). After removing the noodle-strip food from the batter tank (S9), steaming (S3) may next be performed. Here, the noodle-strip food and the batter are steamed together since the steaming operation is performed after contact with the batter has taken place. The steaming operation may be performed, for example, by steaming the noodle-strip food coated with batter on a conveyor belt. After cooling (S4) to stop the steaming process, the noodle-strip food and batter may then be subjected to a freezing operation (S5) to form the microwavable frozen steamed dumplings, which may be packaged (S7).

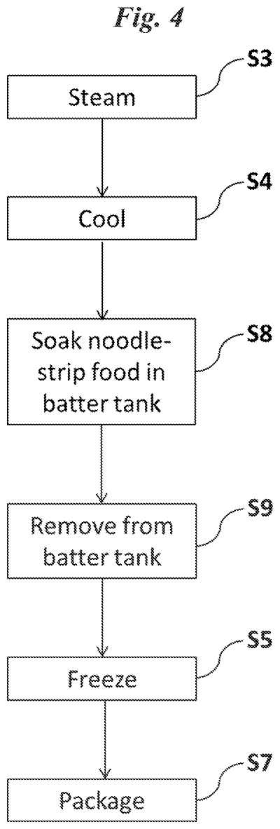

Depicted in FIG. 4 is an alternative method involving the use of a batter tank. The method may first involve steaming a noodle-strip food (S3), for example steaming a raw noodle-strip food on a conveyor belt. Here, the noodle-strip food is steamed prior to contact with the batter. After cooling (S4) to stop the steaming process, the method may next involve soaking the noodle-trip food in a batter tank containing a pre-made batter or a newly made batter (S8) The noodle-strip food coated with batter may next be removed from the batter tank (S9), and subjected to a freezing operation (S5) to form the microwavable frozen steamed dumplings, which may then be packaged (S7).

### A Method of Preparing a Cooked Steamed Dumpling

The present disclosure also provides methods of preparing cooked steamed dumplings from the microwavable frozen steamed dumplings using microwave heating. One of the main benefits of the methods herein is that they are simple and convenient to perform the microwavable frozen steamed dumplings are designed for advantageous moisture retention and a texture/mouthfeel profile akin to traditional steamed dumplings when simply and conveniently heated in a microwave oven using microwave energy. For utmost convenience, the microwavable frozen steamed dumplings are preferably not thawed prior to heating in the microwave oven, but are subjected to microwave heating directly from a frozen state.

A single microwavable frozen steamed dumpling may be heated via microwave oven, or a plurality of microwavable frozen steamed dumplings may be heated together in a microwave oven, for example at least 2, preferably at least 4, preferably at least 6, preferably at least 8, preferably at least 10, and up to 20, preferably up to 18, preferably up to 16, preferably up to 14, preferably up to 12 microwavable frozen steamed dumplings.

One or more microwavable frozen steamed dumplings may be heated in a microwave oven generally at a power of at least 700 W, preferably at least 800 W, preferably at least 900 W, preferably at least 1,000 W, preferably at least 1,100 W and up to 1,500 W, preferably up to 1,400 W, preferably up to 1,300 W, preferably up to 1,200 W. The microwavable frozen steamed dumpling(s) may be heated generally for at least 25 seconds, preferably at least 30 seconds, preferably at least 45 seconds, preferably at least 60 seconds, preferably at least 75 seconds, preferably at least 90 seconds, preferably at least 105 seconds, preferably at least 120 seconds, and up to 240 seconds, preferably up to 225 seconds, preferably up to 210 seconds, preferably up to 195 seconds, preferably up to 180 seconds, preferably up to 165 seconds, preferably up to 150 seconds, preferably up to 135 seconds, or otherwise until reaching a desired internal temperature, for example, an internal temperature of at least 30° C., preferably at least 40° C., preferably at least 45° C., preferably at least 50° C., and up to 75° C., preferably up to 70° C., preferably up to 65° C., preferably up to 60° C., preferably up to 55° C. Of course, microwave times/powers above or below these ranges are also contemplated herein, and as is well known to those of ordinary skill in the art, the length of microwave heating and the microwave power may be adjusted according to the microwave oven manufacturer's instructions, the number of microwavable frozen steamed dumplings desired to be cooked, the type of dumpling to be cooked (e.g., meat dumplings versus dessert type dumplings), etc.

In some embodiments, the one or more microwavable frozen steamed dumplings are heated in the microwave oven without the use of microwave coverings, steamable containers, or specialty heating packaging. As such, the microwavable frozen steamed dumplings may be simply placed onto a microwavable safe dish and subjected to microwave energy.

Examples of microwave coverings include, but are not limited to, plastic bags; plastic wraps such as cling films, polyethylene food wraps (e.g., SARAN wrap from S.C. Johnson Son, Inc.), and polyvinylidene chloride food wraps; paper-based coverings such as paper towel coverings; wetted coverings such as moistened paper towel coverings; microwavable plastic coverings such as microwavable plate covers/splatter guards made from polypropylene, polycarbonate, silicone, and the like.

Examples of steamable containers include, but are not limited to, steamable bags, steamable trays, or any other type of packaging designed to hold maintain an atmosphere of steam throughout the cooking process.

Examples of specialty heating packaging include, but are not limited to, heat susceptors or microwave-absorbing heat generators such as those made of a metallized film, a ceramic, or a metal (e.g., aluminum (lakes), for example those described in US 2003/0203076A1, US 997432482, and US 2016/0242438 each incorporated herein by reference in its entirety.

In some embodiments, the one or more microwavable frozen steamed dumplings are heated in the microwave oven in a steamable bag. The use of a steamable bag may be particularly advantageous when used as a packaging for sale/distribution of the microwavable frozen steamed dumplings and as a steamable container during the cooking operation in the microwave oven to ensure desirable mouthfeel/texture and appearance qualities similar to traditional steamed dumplings.

While their use is contemplated in the disclosed methods, there is no need for, and the methods are preferably performed without, microwave coverings and/or specialty heating packaging, such as those described above.

The methods herein also do not require the addition of water to the microwave oven during the microwave heating process, and preferably, the microwavable frozen steamed dumpling(s) are not in direct contact with water during the heating. When it is stated that the microwavable frozen steamed dumpling(s) is/are not in direct contact with water during the heating, the “water” refers to supplemental water specifically added to aid the heating of the dumpling or to prevent drying of the dumpling skin for example, the microwavable frozen steamed dumpling is preferably not submerged (fully or partially) in water (see e.g., US6329008B1), not placed above a reservoir of water to effect steaming as the water is heated., not covered in a covering wetted with water to moisturize the dumpling skin, etc., during the microwave heating. In this context, the “water” does not include residual moisture present in normal atmosphere (e.g., humid air) nor the residual moisture present on the surface of the microwavable frozen steamed dumpling itself or on an internal surface of a steamable container. For instance, any tiny ice crystals present on the microwavable frozen steamed dumpling or present on an interior surface of a steamable bag (when employed), either of which can be attributed to the freezing process, are not considered herein to be additional water added for the purpose of placing the dumplings in direct contact with water during the heating.

Preferred methods are those in which microwave heat is the only heat source employed for converting the microwavable frozen steamed dumpling into a cooked steamed dumpling, and no other heating technique is employed such as frying (e.g., oil frying, pan frying, etc.), boiling, baking, and the like.

After heating in the microwave oven, it may be desirable to allow the cooked steamed dumpling to rest prior to consuming. By doing so, the dumpling skin may absorb water vapor from the atmosphere leading to improved texture/mouthfeel. Thus, in some embodiments, after heating in the microwave oven, the cooked steamed dumplings may be allowed to rest, for example, for at least 10 seconds, preferably at least 20 seconds, preferably at least 30 seconds, preferably at least 40 seconds, preferably at least 50 seconds, preferably at least 60 seconds, and up to 120 seconds, preferably up to 110 seconds, preferably up to 100 seconds, preferably up to 90 seconds, preferably up to 80 seconds, preferably up to 70 seconds.

The examples below are intended to further illustrate microwavable frozen steamed dumplings, methods of manufacture, and methods of making cooked steamed dumplings therefrom, and are not intended to limit the scope of the claims.

### EXAMPLES

### Frozen Steamed Dumplings

### Noodle-Strip Food

The ingredients used to make the dough of the noodle-strip food in the following examples were as follows: water, wheat flour, soy flour and salt.

The filling ingredients used to make the noodle-strip food in the following examples were as follows: cabbage, pork, pork fat, onions, chicken meat, garlic chives, soy protein concentrate, sake, sesame oil, sugar, gelatin, chicken broth base, MSG, ginger, white pepper, I+G and yeast extract.

### Batter

The batters used to construct the frozen steamed dumpling Examples are given in 1.0 Tables 6-8 and the batter production Examples are given in Table 10. The amount of each component is provided in grams based on a total batter weight of 500 grams, and is also expressed in terms of weight percentage relative to a total weight (100%) of the batter. EXCELLION EM 7 is a very pure roller dried fresh curd sodium caseinate (casein), prepared from fresh skimmed milk, available from FrieslandCampina.

* denotes the example is a comparative example.

The relative amount of batter used to make the frozen steamed dumpling Examples is provided in terms of batter weight (g) per piece (pcs) of noodle-strip food.

### Preparation Methods

The frozen steamed dumplings were prepared according to the following procedure (and depicted in FIG. 1):

To a tray containing 10 cavities/compartments, the requisite amount of the referenced batter was added to each cavity/compartment. 1 piece (pcs) of noodle-strip food was then placed on the batter in each cavity/compartment. The tray containing the noodle-strip food and batter was then steamed in a steam blancher, steam injection 100%, for 11 minutes, followed by cooling in a spiral belt cooler using cold wind at a temperature of 40 to 45° F. (4.4 to 7.2° C.) at a 15 minute cooling time. After cooling, the tray was sent to a spiral belt freezer to freeze and form the frozen steamed dumplings. The frozen steamed dumplings were removed from the tray, and the 10 frozen steamed dumplings thus obtained were packaged together in a steamable bag, and used for the following sensory analysis.

### Evaluation

### Sensory Analysis Procedure

A steamable bag containing 10 frozen steamed dumplings was microwaved in a microwave oven at 1,100-4,200 W for 2 minutes, after which the cooked steamed dumplings were allowed to rest in the steamable bag for 1 minute. The cooked steamed dumplings were then removed from the steamable bag and evaluated by trained panelists with experience in is profiling and prescreened for their sensory acuity. The trained panelists evaluated the cooked steamed dumplings according to color, shine, mouthfeel, texture, and stickiness, and provided a rating for each according to the rating criteria in Tables 1-5, respectively.

TABLE 1
Color rating

| Rating | Description | Color outcome |
|---|---|---|
| 3 | Excellent | White |
| 2 | Good | Slightly yellow or off-white |
| 1 | Bad | Yellow |

TABLE 2
Shine rating

| Rating | Description | Shine outcome |
|---|---|---|
| 3 | Excellent | Moistened; shiny; succulent appearance |
| 2 | Good | Slightly dry appearance; somewhat shiny |
| 1 | Bad | Dry appearance; no shine |

TABLE 3
Mouthfeel rating

| Rating | Description | Mouthfeel outcome |
|---|---|---|
| 3 | Excellent | Smooth |
| 2 | Good | Mostly smooth |
| | | (or smooth but too oily) |
| 1 | Bad | Rough |

TABLE 4
Texture rating

| Rating | Description | Texture outcome |
|---|---|---|
| 3 | Excellent | Soft |
| 2 | Good | Not firm/slightly soft |
| | | (or overly soft) |
| 1 | Bad | Firm |

TABLE 5
Stickiness rating

| Rating | Description | Stickiness outcome |
|---|---|---|
| 3 | Excellent | Not sticky |
| 2 | Good | Not sticky but too much moisture |
| 1 | Bad | Sticky |

Frozen steamed dumplings which provided cooked steamed dumplings receiving all “2” (good) or “3” (excellent) sensory ratings were considered to be “microwavable” (i.e., microwavable frozen steamed dumpling).

### Sensory Evaluation

Frozen steamed dumpling Examples 1-5 are presented in Table 6. As shown, the frozen steamed dumplings prepared without batter (negative control) provided cooked steamed dumplings with poor shine appearance and unacceptable texture (firm) (Example 1; comparative). The use of a conventional batter containing water, soy sauce, rice flour, egg white powder, casein, lecithin, and canola oil provided cooked steamed dumplings with unacceptable color (yellow), mouthfeel (rough), and texture (firm) properties (Example 2; comparative). The removal of soy sauce led to improved color (slightly yellow), but the mouthfeel (rough) and texture (firm) of the cooked steamed dumplings remained unsatisfactory (Example 3; comparative).

Further eliminating the rice flour and egg white powder, reducing the amount of oil, and drastically increasing the water content to 88.9 wt. % provided cooked steamed dumpling products with acceptable sensory ratings (Examples 4 and 5). While the batter made with lecithin provided good color (Example 4), the use of casein as emulsifier led to improved whiteness in the cooked steamed dumpling (Example 5).

TABLE 6
Frozen Steamed Dumpling Examples 1-5

| Batter | *Example 1 | *Example 2 | | *Example 3 | | Example 4 | | Example 5 | |
|---|---|---|---|---|---|---|---|---|---|
| ingredients | Negative Control | g | % | g | % | g | % | g | % |
| water | No batter | 183.8 | 36.8 | 199.8 | 40.0 | 444.5 | 88.9 | 444.5 | 88.9 |
| Soy sauce | | 16 | 3.2 | — | — | — | — | — | — |
| Rice flour | | 32 | 6.4 | 32 | 6.4 | — | — | — | — |
| Egg white powder | | 2.1 | 0.4 | 2.1 | 0.4 | — | — | — | — |
| EXCELLION | | 6 | 1.2 | 6 | 1.2 | — | — | 10 | 2.0 |
| EM 7 | | | | | | | | | |
| Lecithin | | 10 | 2.0 | 10 | 2.0 | 10 | 2.0 | — | — |
| Canola oil | | 250.1 | 50.0 | 250.1 | 50.0 | 45 | 9.0 | 45 | 9.0 |
| Xanthan gum | | — | — | — | — | 0.5 | 0.1 | 0.5 | 0.1 |
| Total | — | 500 | 100 | 500 | 100 | 500 | 100 | 500 | 100 |

| | | | | | |
|---|---|---|---|---|---|
| Batter Weight | — | 2 g/pcs | 2 g/pcs | 2 g/pcs | 2 g/pcs |
| Color | 2 | 1 | 2 | 2 | 3 |
| Shine | 1 | 2 | 2 | 2 | 2 |
| Mouthfeel | 2 | 1 | 1 | 2 | 2 |
| Texture | 1 | 1 | 1 | 2 | 2 |

To examine the effect of the batter weight, frozen steamed dumpling Examples 6-10 were prepared using batters formulated with 90 wt. % water, 1.0 wt. % casein, and 9 wt. % oil, and the results are presented in Table 7. The use of 1 g of batter per piece of noodle-strip food provided acceptable appearance and mouthfeel, but led to cooked steamed dumplings which were firm and lacked surface moisture thereby rendering them sticky (Example 6). Doubling the batter weight to 2 g/pcs improved the texture and stickiness of the cooked steamed dumplings (Example 7), while further hatter weight increases to 3 g/pcs and 4 g/pcs provided cooked steamed dumplings most preferred. by the panelists (Example 8 and 9, respectively). Further increasing the batter weight to 5 g/pcs afforded a texture which was overly soft and having slightly too much moisture on the surface, though the cooked steamed dumplings were still acceptable to the panelists.

TABLE 7
Frozen Steamed Dumpling Examples 6-10

| Batter | Example 6 | | Example 7 | | Example 8 | | Example 9 | | Example 10 | |
|---|---|---|---|---|---|---|---|---|---|---|
| ingredients | g | % | g | % | g | % | g | % | g | % |
| Water | 450 | 90.0 | 450 | 90.0 | 450 | 90.0 | 450 | 90.0 | 450 | 90.0 |
| EXCELLION | 5 | 1.0 | 5 | 1.0 | 5 | 1.0 | 5 | 1.0 | 5 | 1.0 |
| EM 7 | | | | | | | | | | |
| Canola oil | 45 | 9.0 | 45 | 9.0 | 45 | 9.0 | 45 | 9.0 | 45 | 9.0 |
| Total | 500 | 100 | 500 | 100 | 500 | 100 | 500 | 100 | 500 | 100 |

| | | | | | | | | | |
|---|---|---|---|---|---|---|---|---|---|
| Batter Weight | 1 g/pcs | 2 | g/pcs | 3 | g/pcs | 4 | g/pcs | 5 | g/pcs |
| Water | 9.0 g/bag | 18.0 | g/bag | 27.0 | g/bag | 36.0 | g/bag | 45.0 | g/bag |
| Oil | 0.9 g/bag | 1.8 | g/bag | 2.7 | g/bag | 3.6 | g/bag | 4.5 | g/bag |

| | | | | | |
|---|---|---|---|---|---|
| Color | 3 | 3 | 3 | 3 | 3 |
| Shine | 2 | 2 | 3 | 3 | 3 |
| Mouthfeel | 2 | 2 | 3 | 3 | 3 |
| Texture | 1 | 2 | 3 | 3 | 2^{(a)} |
| Stickiness | 1 | 3 | 3 | 3 | 2 |

^{(a)}overly soft

Next, the effect of the ratio of water to oil in the hatters was examined in Table 8. As can he seen, every ratio of water to oil tested provided cooked steamed dumplings with excellent sensory qualities (Examples 9, and 11-13), albeit when the ratio of water to oil was lowered to 3.125:1, the mouthfeel of the cooked steamed dumplings were slightly oily, though still in the acceptable range (Example 13).

TABLE 8
Frozen Steamed Dumpling Examples 9 and 11-13

| Batter | Example 9 | | Example 11 | | Example 12 | | Example 13 | |
|---|---|---|---|---|---|---|---|---|
| ingredients | g | % | g | % | g | % | g | % |
| Water | 450 | 90.0 | 425 | 85.0 | 400 | 80.0 | 375 | 75.0 |
| EXCELLION | 5 | 1.0 | 5 | 1.0 | 5 | 1.0 | 5 | 1.0 |
| EM 7 | | | | | | | | |
| Canola oil | 45 | 9.0 | 70 | 14.0 | 95 | 19.0 | 120 | 24.0 |
| Total | 500 | 100 | 500 | 100 | 500 | 100 | 500 | 100 |
| Batter Weight | 4 | g/pcs | 4 | g/pcs | 4 | g/pcs | 4 | g/pcs |
| Water | 36.0 | g/bag | 34.0 | g/bag | 32.0 | g/bag | 30.0 | g/bag |
| Oil | 3.6 | g/bag | 5.6 | g/bag | 7.6 | g/bag | 9.6 | g/bag |

| | | | | |
|---|---|---|---|---|
| Color | 3 | 3 | 3 | 3 |
| Shine | 3 | 3 | 3 | 3 |
| Mouthfeel | 3 | 3 | 3 | 2^{(a)} |
| Texture | 3 | 3 | 3 | 3 |
| Stickiness | 3 | 3 | 3 | 3 |

^{(a)}smooth but too oily

### Batter Stability Procedure

The stability of the batters was evaluated in two ways:
1) Newly made batters were assembled in a beaker and were mixed for 30 minutes, after which the mixing was stopped and the batters were visually inspected for phase separation.
2) Newly made batters were added to a microwave safe tray, each batter being tested in quadruplicate by being placed into 4 cavities/compartments in the tray. The tray was then microwaved in a microwave oven at 1,100-1,200 W for 2 minutes, and allowed to rest in the microwave oven for 1 minute. The batters were then visually inspected for phase separation.

The batters were rated according to the stability rating criteria of Table 9.

TABLE 9
Stability rating

| Rating | Description | Stability outcome |
|---|---|---|
| A | Excellent | No splitting/phase separation |
| B | Good | Slight splitting/phase separation |
| C | Bad | Split/separated into distinct well-defined phases |

Batters receiving “A” (excellent) or “B” (good stability ratings were considered to be suitable for production herein.

### Batter Stability Evaluation

Batter production Examples 1-6 are presented in Table 10, Batter production Example 1 was the batter used to make frozen steamed dumpling Examples 6-10. Batter production Examples 1-3 were formulated without stabilizing agent, in this case xanthan gum, and these batters were found to slightly separate after 30 minutes of mixing. Despite this slight separation, these batters were still suitable in production, particularly when constructed as newly made batters to minimize any phase separation tendencies.

Batter production Examples 4-6 were made with increasing amounts of xanthan gum, and all three batters were stable after 30 minutes of mixing (no splitting/phase separation). The highest content of xanthan gum tested at 1.0 wt. % caused the batter to be of relatively high viscosity prior to heating (batter production Example 6), but the elevated viscosity caused no problems with product quality. After microwave heating, the batters containing 0.5 and 1.0 wt. % xanthan gum (batter production Examples 5 and 6, respectively) were quite stable with no signs of splitting, while the batter with the lowest content of xanthan gum at 0.1 wt. % (batter production Example 4) led to some splitting between the oil and water phases after heating, although such splitting caused no problems with product quality.

TABLE 10
Batter Production Examples 1-6

| | Batter Production | | Batter Production | | Batter Production | | Batter Production | | Batter Production | | Batter Production | |
|---|---|---|---|---|---|---|---|---|---|---|---|---|
| Batter | Example 1 | | Example 2 | | Example 3 | | Example 4 | | Example 5 | | Example 6 | |
| ingredients | g | % | g | % | g | % | g | % | g | % | g | % |
| Water | 450 | 90.0 | 440 | 88.0 | 430 | 86.0 | 449.5 | 89.9 | 447.5 | 89.5 | 445 | 89.0 |
| EXCELLION | 5 | 1.0 | 15 | 3.0 | 25 | 5.0 | 5 | 1.0 | 5 | 1.0 | 5 | 1.0 |
| EM 7 | | | | | | | | | | | | |
| Canola oil | 45 | 9.0 | 45 | 9.0 | 45 | 9.0 | 45 | 9.0 | 45 | 9.0 | 45 | 9.0 |
| Xanthan gum | — | — | — | — | — | — | 0.5 | 0.1 | 2.5 | 0.5 | 5 | 1.0 |
| Total | 500 | 100 | 500 | 100 | 500 | 100 | 500 | 100 | 500 | 100 | 500 | 100 |

| | | | | | | | |
|---|---|---|---|---|---|---|---|
| Stability | After 30 | B | B | B | A | A | A^{(a)} |
| | minutes of | | | | | | |
| | mixing | | | | | | |
| | After heating | — | — | — | B | A | A |

^{(a)}Viscosity slightly high

Where a numerical limit or range is stated herein, the endpoints are included. Also, all values and subranges within a numerical limit or range are specifically included as if explicitly written out.

As used herein the words “a” and “an” and the like carry the meaning of “one or more.”

The present disclosure also contemplates other embodiments “comprising”, “consisting of” and “consisting essentially of”, the embodiments or elements presented herein, whether explicitly set forth or not.

Obviously, numerous modifications and variations of the present invention are possible in light of the above teachings. It is therefore to be understood that, within the scope of the appended claims, the invention may be practiced otherwise than as specifically described herein.

All patents and other references mentioned above are incorporated in full herein by this reference, the same as if set forth at length.

1. A microwavable frozen steamed dumpling, comprising:
a noodle-strip food; and
a batter;
wherein the batter comprises water in an amount of at least 70 wt. %, based on a total weight of the batter.

2. The microwavable frozen steamed dumpling of claim 1, wherein the water is present in the batter in an amount of 81 to 91 wt. %, based on a total weight of the batter.

3. The microwavable frozen steamed dumpling of claim 1, wherein the batter further comprises an oil.

4. The microwavable frozen steamed dumpling of claim 3, wherein the oil is present in the batter in an amount of 5 to 25 wt. %, based on a total weight of the batter.

5. The microwavable frozen steamed dumpling of claim 3, wherein a weight ratio of water to the oil in the batter is from 3:1 to 15:1.

6. The microwavable frozen steamed dumpling of claim 3, wherein the oil is canola oil.

7. The microwavable frozen steamed dumpling of claim 1, wherein the batter further comprises an emulsifier.

8. The microwavable frozen steamed dumpling of claim 7, wherein the emulsifier is present in the batter in an amount of 0.1 to 5 wt. %, based on a total weight of the batter.

9. The microwavable frozen steamed dumpling of claim 7, wherein the emulsifier is at least one selected from the group consisting of casein and lecithin.

10. The microwavable frozen steamed dumpling of claim 1, wherein the batter further comprises a gum.

11. The microwavable frozen steamed dumpling of claim 10, wherein the gum is present in the batter in an amount of 0.01 to 2 wt. %, based on a total weight of the batter.

12. The microwavable frozen steamed dumpling of claim 10, wherein the gum is xanthan gum.

13. The microwavable frozen steamed dumpling of claim 1, wherein the batter is present in an amount of 1.5 to 5.5 g per piece of the noodle-strip food.

14. The microwavable frozen steamed dumpling of claim 1, wherein the batter is substantially free of grain flour.

15. The microwavable frozen steamed dumping of claim 1, wherein the batter is substantially free of starch.

16. The microwavable frozen steamed dumpling of claim 1, wherein the batter is substantially free of protein.

17. A method of making the microwavable frozen steamed dumpling of claim 1, comprising:
contacting the noodle-strip food with the batter; and
freezing to form the microwavable frozen steamed dumpling.

18. The method of claim 17, wherein the noodle-strip food is raw prior to contacting with the batter, and the method further comprises steaming the noodle-strip food after contacting with the batter.

19. The method of claim 17, further comprising steaming the noodle-strip food prior to contacting with the batter.

20. A method of preparing a cooked steamed dumpling, comprising:
heating the microwavable frozen steamed dumpling of claim 1 in a microwave oven.

21. The method of claim 20, wherein the microwavable frozen steamed dumpling is heated in the microwave oven in a steamable bag.

22. The method of claim 20, wherein the microwavable frozen steamed dumpling is heated in the microwave oven without the use of a heat susceptor or a microwave-absorbing heat generator.
